(19) United States
(12) Patent Application Publication
(10) Pub. No.: US 2001/0048536 A1
(43) Pub. Date: Dec. 6, 2001

(54) Photographic image capturing device with light emitting diodes

(76) Inventors: Mathias Lehmann, Zurich (CH); Hansjorg Rotach, Effretikon (CH); Peter Kobel, Spreitenbach (CH); Georg Von Tobel, Wettingen (CH)

Correspondence Address: Patrick C. Keane, BURNS, DOANE, SWECKER & MATHIS, L.L.P., P.O. Box 1404, Alexandria, VA, 22313-1404, US

(21) Appl. No.: 09/864,185

(22) Filed: May 25, 2001

(30) Foreign Application Priority Data
May 26, 2000 (EP) 00 110 974.3

(51) Int. Cl. H04N 1/46

(52) U.S. Cl. 358/513

(57) ABSTRACT

Photographic capturing device for the capturing of photographic image information from photographic media, with a light integrator which receives light emitted from LED chips with a respectively LED chip specific color, homogenizes the light and emits it from an output opening, in order to illuminate a photographic medium carrying photographic image information, and a detection means for detecting the light modulated by the photographic medium according to the image information, whereby a multitude of LED chips of equal emission color are provided for at least three different colors, which LED chips are mounted on at least one heat conducting substrate and in heat conducting contact therewith.

### FIELD OF THE INVENTION

The present invention relates to a photographic capturing device, such as for example a scanner or a printer for the capturing (in color) of photographic image information from photographic media, especially films, by using light emitting diodes.

### BACKGROUND OF THE INVENTION

A scanner for the scanning of photographic films, which includes light emitting diodes as light source, is known from EP 0 948 191 A2 (corresponding U.S. Pat. No. 5,982,957). In that device, light from differently colored light emitting diodes is mixed in an integrated device, a film to be shone-through is exposed to the mixed light, and the light transmitted by the film is captured by a CDD detector. The purpose of this arrangement is to achieve the most optimal spectral sensitivity for the scanner. The spectral sensitivity of the scanner results from a combined function of the spectrum of the light source and the spectral sensitivity of the CCD sensor. The desired spectral sensitivity of the scanner is achieved in that the emission spectrum of the light source is mixed by suitable combination of LEDs with different spectral emission characteristics. The integration device provides for a mixing of the different spectra of the LEDs. Conventional LEDs with a lens body are thereby used which are mounted on a circuit board.

Conventional LEDs consist essentially of a lens body from which connecting wires extend for electrical contact with the anode and cathode of the actual (semiconductor) light emitting diode which is referred to in the following as LED chip. The LED chip takes up only a small space in the interior of the lens body. The lens body is typically dome-shaped and consists, for example, of epoxy resin. The LED chip with lens body and connecting wires is herein referred to as LED. In order to channel the light of a large number of LEDs of different spectra into an integrator, the above mentioned EP 0 948 191 A2 provides for conically tapered light collectors (“concentrator cones”) with reflecting interior surfaces, the smaller ends of which enter into the light integrator with a number of LEDs being positioned that the larger ends.

### SUMMARY OF THE INVENTION

It is an object of the invention to provide an image capturing device which uses light emitting diodes and still enables short exposure times for the image capturing and a compact and cost-efficient construction of the light source.

This object is achieved with a photographic capturing device in accordance with the invention for the capturing of photographic image information from photographic media, which device includes a light integrator for receiving light emitted from LED chips in a color specific for the respective LED chip, for homogenizing the light and for emitting it from an output opening for illumination of a photographic image information carrying photographic medium. The device further includes a detector means for detecting the light modulated by the photographic medium according to the image information. A multitude of LED chips of equal emission color are preferably provided for at least three different colors, which chips are mounted on at least one heat conducting substrate with which the LED chips are in heat conducting contact.

In accordance with the invention, not whole LEDs (with lens body) are used but only the actual semiconductor-light emitting diode, namely the LED chip. This provides two advantages. First, a significantly denser packing of the LED chips (number of LED chips per surface) is possible than in an arrangement of conventional LEDs (with lens body), since the lens body or the LED housing occupies a large part of the base surface of the LED. The ratio of the base surface of an LED chip to the base surface of the LED housing is about one to two orders of magnitude. For example, the diameter of LEDs is about 3 to 5 mm and the edge length of an LED chip is about 0.1 to 0.5 mm. A high light density on a small area can be achieved in accordance with invention, since individual LED chips are positioned on a substrate at the smallest possible distance, which is preferably smaller than four times the diameter of an LED chip and especially preferably about the same or smaller than the diameter of an LED chip. As a result, the conical light concentrator is obviated and the LED chips are preferably positioned directly at the input openings of a light integrator, whereby a more effective light coupling into the light integrator can be achieved, since there is no reflection losses at the inner surfaces of the conical light concentrator. The LED chips preferably cover more than 5%, especially preferably more than 10% or more than 25% of the substrate surface.

Furthermore, the use of LED chips in the manner in accordance with invention provides for a good heat removal. The conventional lens body or housing body of an LED has only marginal heat conducting properties. In accordance with the invention, the LED chip is not embedded in the lens body or housing body but is brought into heat conducting contact with a substrate, whereby the substrate has a lower heat resistance than conventional circuit boards. The heat resistance is preferably at least one order of magnitude, preferably about two orders of magnitude below that of the conventional circuit board material FR-4. Ceramics such as aluminum oxide or aluminum nitride qualify as materials which have a corresponding heat conductance of 20 W/m-K and more. If the type of electrical contacts permits, the substrate can even be metallic (copper, aluminum, . . . ) in order to further improve the heat conductance (for example to 400 W/mK for copper).

The LED chip is preferably placed on the substrate, for example by bonding or SMT (surface mounting technique) in such a way that the specific heat contact resistance between substrate and LED chip is as low as possible (for example less than 10 K cm²/W, preferably less than 1 K cm²/W). If this contact is produced by conductive silver adhesive (epoxy base) the corresponding value is preferably less than 0.3 K cm²/W. This value is proportional to the thickness of the adhesive layer, which is in the order of 10 to 100 micrometers. Since the base surface of the LED chips even at very dense packing on the substrate is significantly smaller than the substrate surface occupied by each LED chip, the contribution of the contact between LED chip and substrate to the total heat resistance is correspondingly high. The LED chips are preferably not made in one-piece with the substrate, i.e. no single wafer construction is chosen, so that a substrate with optimal heat conducting properties can be selected. A material is especially preferably used as substrate which has better heat conducting properties than the semiconductor materials used in the LED chip manufacture.

The removal of heat from the substrate can be carried out, for example, by conventional cooling bodies, possibly with fans or with even more efficient methods (cooling liquid). If the substrate itself does not function as cooling body, the thermal contact between substrate and cooling body (heat sink) is preferably produced with heat conducting pastes or foils, whereby a specific heat resistance of preferably at most 0.3 K cm²/W is targeted. The thickness of corresponding heat conducting foils is thereby in the order of 0.1 mm.

The total heat resistance from the light emitting transition to the ambient air in the end determines the maximum current with which the LED chips can be operated at a certain packing density. Thus, with a maximum permissible temperature of, for example, 100 degrees Celsius at the transition, a smaller heat resistance allows higher currents per LED and a higher packing density. The reduction of the total heat resistance consequently corresponds in each case to an increase in the mean light density of the light emitting diode arrangement.

The LED chips are preferably mounted on the substrate in such a way that they protrude therefrom and consequently are not enclosed by the substrate. The substrate is preferably positioned on that side of the LED chips which is directed away from the light integrator. The substrate can thereby be made opaque, which results in a broad spectrum of substrate materials with good heat conductance. The substrate material is preferably light reflective at its surface at least between individual LED chips in order to redirect light which is exiting from the light integrator through the input openings.

The LED chips are preferably heat conductively connected with the substrate and the substrate is preferably provided with such a low heat resistance that more heat can be conducted away from the LED chip to a heat sink through the heat conducting contact between LED chip and the substrate than is conventionally achievable and conventionally occurs in the normal operation by heat conductance through the electrical connecting wires or through the lens body of conventional LEDs. The combination of LED chips and substrate is referred to as a light emitting diode arrangement. Preferably at least three light emitting diode arrangements are provided.

The substrate is then preferably connected with a heat sink, for example, a cooling body, a cooling sheet, a fan, a cooling water circuit, etc. The heat sink takes up the heat given off by the LED chips and transports it away through the heat conducting substrate so that a desired operating temperature for the LED chips is maintained.

If required, the spectral emission spectrum of the LED chips is adapted to a desired spectrum by filtering. Especially infrared portions are removed. Since the filtering efficiency especially of interference filters depends on the optical wavelength and thereby on the angle of incidence of the light, the emission of the LED chips is preferably rectified prior to the filtering. Preferably a multitude of small lenses or a microlens array is used for this purpose which is placed in front of the LED chips on the light integrator side in such away that a small lens is positioned in front of each LED chip which lens rectifies the emission somewhat forwardly and the size of which is preferably about equal to the distance between two neighbouring LED chips. In this manner, a more exact filtering is achieved than without a microlens array. The filter (interference filters) is preferably positioned after the microlens array. A further microlens array is alternatively positioned after the interference filter in order to further process the emission before it enters into the integrator.

The light integrator is preferably constructed diffusely and multiply reflective and especially has a cavity in which the light emitted thereinto is reflected on the interior surfaces. A typical integrator is, for example, an Ulbricht sphere. However, the shape of the cavity can also differ from a sphere and can be formed, for example, as a multigon or semi sphere or can have several separate reflective surfaces. The cavity is preferably provided with several entry openings, whereby a light emitting diode arrangement with a multitude of LED chips is provided at each entry opening. The light emitting diode arrangements are preferably placed in such away that they illuminate at least 50 percent of the inner surface of the cavity. This increases the homogenizing effects of the cavity with respect to the light intensity profile at the output opening of the cavity and furthermore allows it to make the cavity as small as possible in order to achieve a higher light intensity at the output. The light emitting diode arrangements are preferably placed in such away that the output opening of the cavity is not directly illuminated.

The cavity preferably has a reflectivity of above 90%, especially preferably above 95% or 99%. For that purpose, the cavity is preferably coated with a white coating which diffusely reflects the light. For example, barium sulfate. “Spectralon” from the company Labsphere with a high reflection coefficient of 99% can also be used as reflective material. The inner surface of the cavity is especially preferably lined with a flexible material, for example, in the form of a foil. For example the material described in U.S. Pat. No. 5,892,621 and sold by the Gore company under the name “Whitestar” can be used. However, any other materials such as lacquers, foils or coatings can be used to achieve reflection.

The substrate can also be provided with a reflective surface at least in the gap between the LED chips. This is especially advantageous when the light emitting diode arrangements are positioned directly at the input openings of the cavity. In that case, the substrate forms a reflective wall of the cavity.

If several light emitting diode arrangements are used, the geometry of the positioning is preferably the same for all relative to the output opening, i.e. preferably the same distance to the output opening and/or the same relative angle.

A cavity or another arrangement, for example, of (planar or curved) mirrors or other diffusely reflective planar or curved wall elements can be used as light integrator wherein the multiple reflection between the different surfaces leads to a homogenization of the light.

The substrates are preferably planar, but can also be adapted, for example, to the inner curvature of the cavity. If the cavity is a sphere, the substrates with the LED chips thereon can follow the curvature of the sphere.

Preferably, (color-) groups of a multitude (for example, 100 or more) of LED chips of the same color or with a same spectral emission characteristics are used, whereby a light emitting diode arrangement can have a single color group or LED chips of different color groups. LED chips in three, four or more colors are preferably provided, which preferably cover the visual spectrum or fall into it, whereby, for example, two are respectively at the upper and lower edge of the visual spectrum (for example, red and blue). In addition to the light emitting diode arrangements with LED chips in accordance with the invention, conventional LEDs can be used, especially in the infrared region, which are used especially in connection with a scratch suppressing software. Separate input openings into the cavity can be provided for these individual conventional LEDs.

LED chips of different colors typically have different light intensities. Furthermore, depending on the detection means (for example photoelectric converter or light sensitive and color sensitive medium) different intensities are necessary for the different colors. In order to keep the image capture time as short as possible, the number of LED chips of one group (which means of one color) is adapted to the requirements, so that preferably about the same emission time frame is achieved for each color group. The image capture in process can thereby be further accelerated. For example, the light intensity of the red LED chips is typically higher than the one of the green or blue chips. Thus, if LED chips of three different colors are provided, more blue and green chips are provided than red LED chips, if any CCD sensor is provided. In the case of photographic paper as detection means, more red than blue and green LED chips are provided.

If a photoelectric converter is used as the detection means, especially a CCD, it is preferably not equipped with spectral filters and thereby cannot differentiate between different colors, in order to increase the light sensitivity and/or the resolution (number of pixels) and to reduce the image capture time or to increase the image resolution. In order to nevertheless correctly capture the color properties of a photographic medium (resolved by area) at any given time only the LED chips of one group (of one color, or of one spectrum) are activated to emit light. The signals (charges) produced at that time in the photoelectric converter can thereby be positively associated with one specific color. For this purpose, the control of the groups is preferably sequential and adapted to or synchronized with the read-out of the signals from the photoelectric converter. A duration of less than 100 milliseconds, preferably less than 10 milliseconds is desired for the image capture of a photographic medium (an image of a film). Because of the quick reaction time of the LED chips, the time difference between the activation of the differently colored LED chips is preferably (significantly) shorter than the emission time. Of course, longer dark phases are also possible, for example during the transport of the film.

The light exiting the light integrator reaches the photographic medium directly or through light conducting means (for example lenses, mirrors, shutters) and is modulated therein in its intensity by transmission or reflection and, for color images, is modulated spectrally dependent. The output opening of the light integrator can have about the same size as the photographic medium to be exposed to light. In that case, the photographic medium is preferably positioned at a distance to the output opening which is small relative to the dimensions of the output opening. Alternatively, the output opening can be smaller than the dimensions of the photographic medium (for example less than half or one-quarter of the area of a frame) to allow a reduction of the size of the light integrator and thereby the number of the LED chips. In that case, the output opening is preferably optically-enlarged by way of a projection optic positioned between the output opening and the photographic medium so that the photographic medium is completely illuminated (for measurement in reflection) or shone-through (for measurement in transmission). Lens systems and preferably a condenser lens are used herefor. The above-mentioned projection optic is in the following referred to as second optic. A first optic is preferably provided besides this second optic, which first optic projects the photographic medium onto the detection means. In that case, and in case of measurement in transmission, the second optic is preferably constructed such that it enlarges the output opening and projects it onto the input opening of the first optic.

Furthermore, a holding arrangement is preferably provided for the holding of photographic medium of different format. If the photographic medium is a film, the holding arrangement is preferably a film mask which fits the different film formats (for example APS-film, 135-film). The holding arrangement has at least two different masks in order to hold the photographic medium of different format in the position preselected for the image capture. In addition, an exchange mechanism is provided for selectively bringing one of the available masks into the preselected image capturing position. This exchange mechanism can especially be a rotor with several film masks mounted along the circumference thereof. In combination therewith, the position of the above-mentioned second optic can be changed or another second optic inserted between the output opening and photographic medium by way of an exchange mechanism, in order to adapt the size of the light beam from the light integrator to the respectively used mask. In this manner, the light intensity can be optimally used for each format. Particularly, shorter exposure times can be achieved for small formats.

If a color sensitive detection means is used which can distinguish between different colors, a simultaneous illumination or illumination overlapping in time is preferably carried out with the groups of LED chips in order to further shorten the image capturing process. This is especially advantageous when a photographic paper or a CCD sensor with incorporated color filters is used as the detection means.

### BRIEF DESCRIPTION OF THE DRAWINGS

Further features significant for the invention are discussed in the following description of different embodiments with reference to the drawings. Features of different embodiments can thereby be combined. Equal reference numbers referred to equal parts.

FIG. 1 is a top view of a light emitting diode arrangement in accordance with invention;

FIG. 2 shows a cross-section through an Ulbricht sphere with light emitting diode arrangements;

FIG. 3 shows a light emitting diode arrangement with microlens array;

FIG. 4A shows an optical arrangement with condenser lens between the Ulbricht sphere and the film;

FIG. 4B shows an optical arrangement as in FIG. 4A, however with a fresnel lens as condenser lens;

FIG. 5 is a side view of an image capturing arrangement in accordance with the invention;

FIG. 6 is a view from obliquely below of an Ulbricht sphere with condenser lens and film;

FIG. 7 shows a cross-section through the optical projection portion of the capturing device in accordance with invention; and

FIG. 8 is a perspective view of the projection portion according to FIG. 7.

### DETAILED DESCRIPTION OF THE PREFERRED EMBODIMENT

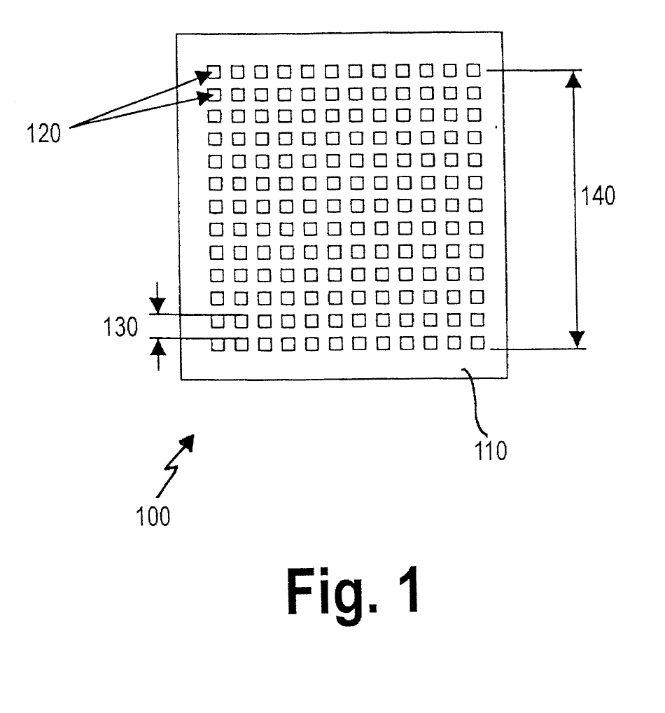

FIG. 1 shows a light emitting diode arrangement 100 with a substrate 110 and a multitude of LED chips 120. The LED chips can be differently shaped (for example round or rectangular). The LED chips, for example, can have an edge length of 0.2 to 0.4 mm. In that case, for example, the spacing 130 between the individual LED chips is 0.5 to 1 mm. The LED chips can stretch over a distance 140 of several centimeters. In that case, for example more than 100 LED chips can be positioned on the substrate 110.

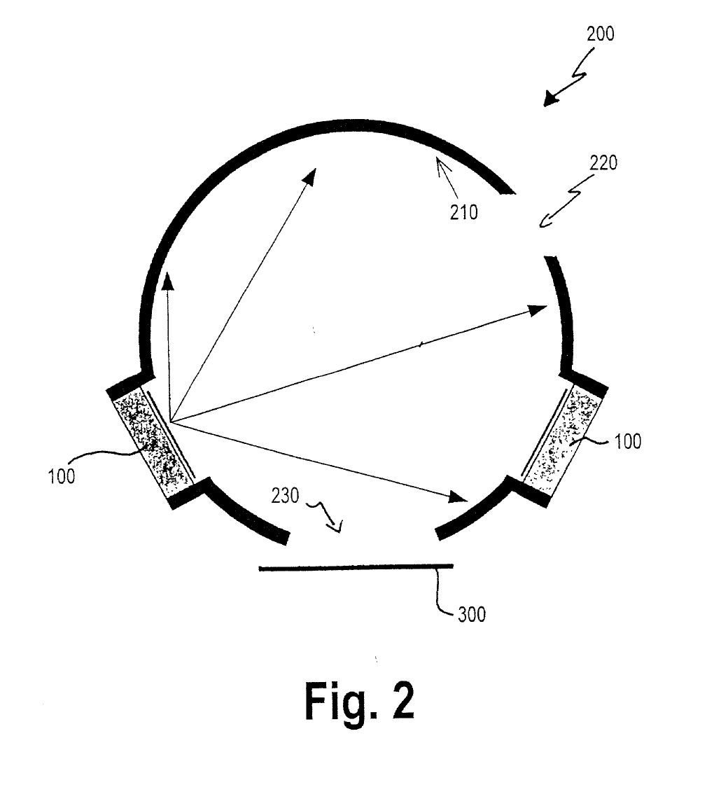

FIG. 2 shows an Ulbricht sphere 200 in cross-section, which functions as light integrator. Light emitting diode arrangements 100 are positioned in the input openings of the Ulbricht sphere 200, which emit light into the cavity which is reflected by the white, diffusely reflective surface 210 of the Ulbricht sphere. A further input opening 220 for conventional (for example infrared) LEDs with lens body can be provided. As is apparent from FIG. 2, the light emitting diode arrangements 100 are in the lower half of the Ulbricht sphere and do not directly illuminate the exit opening 230 positioned at the bottom. In the embodiment shown in FIG. 2, the film 300 is positioned directly below the Ulbricht sphere 200 and is shone-through by the light exiting from the Ulbricht sphere.

The output opening 230 can have a shape which is adapted to a film frame or an individual image (“frame”). It is preferably somewhat larger than the individual image to be shone-through (for example about 30% larger). The film 300 is as close as possible to the output opening. The distance between the film and the output opening is preferably smaller than the dimensions of the output opening.

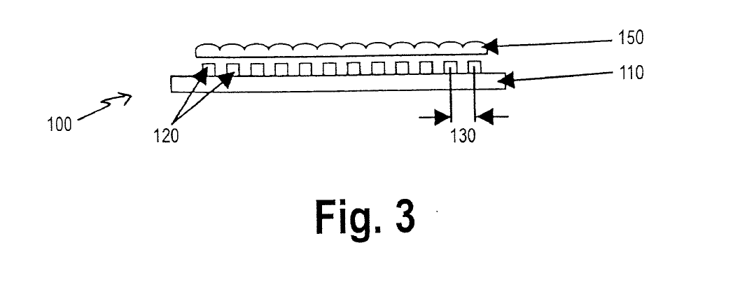

FIG. 3 shows a light emitting diode arrangement 100 with substrate 110, LED chips 120 and microlens array 150. As is apparent from FIG. 3, the individual LED chips are positioned on the substrate 110, and packed thereon as densely as possible, for example, by the “chips-on-board” technique. The LED chips 110 protrude from the substrate towards the inside of the cavity 200. A microlens array of a multitude of microlenses is positioned directly above the LED chips, whereby respectively each microlens is associated with one LED chip. A microlens is thereby advantageously positioned above each LED chip. The distance between LED chip and microlens is preferably in the same order of magnitude as the diameter of distance 130 in order to keep the arrangement compact. Interference filters, which are not illustrated, can be positioned after the microlens array 150.

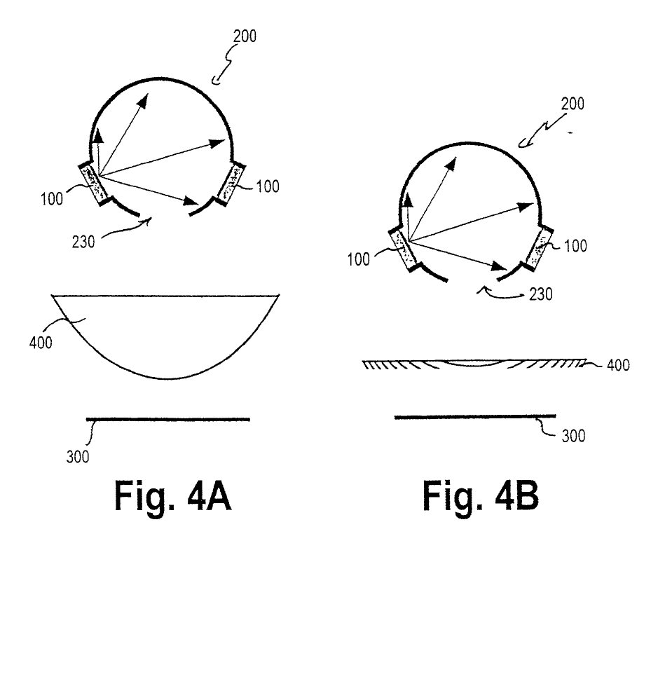

FIGS. 4A and 4B show an embodiment alternative to the one of FIG. 2, wherein an optical arrangement (projection optic) is located between the plane in which the film is transported and the light integrator 200. The optical arrangement is constructed as a condenser lens 400. In FIG. 4 A this is a conventional condenser lens which can be aspherical, for example. In FIG. 4B the condenser lens 400 is constructed as a fresnel lens. This allows a more compact construction. Condenser systems with more than one lens (for example 2) are also possible.

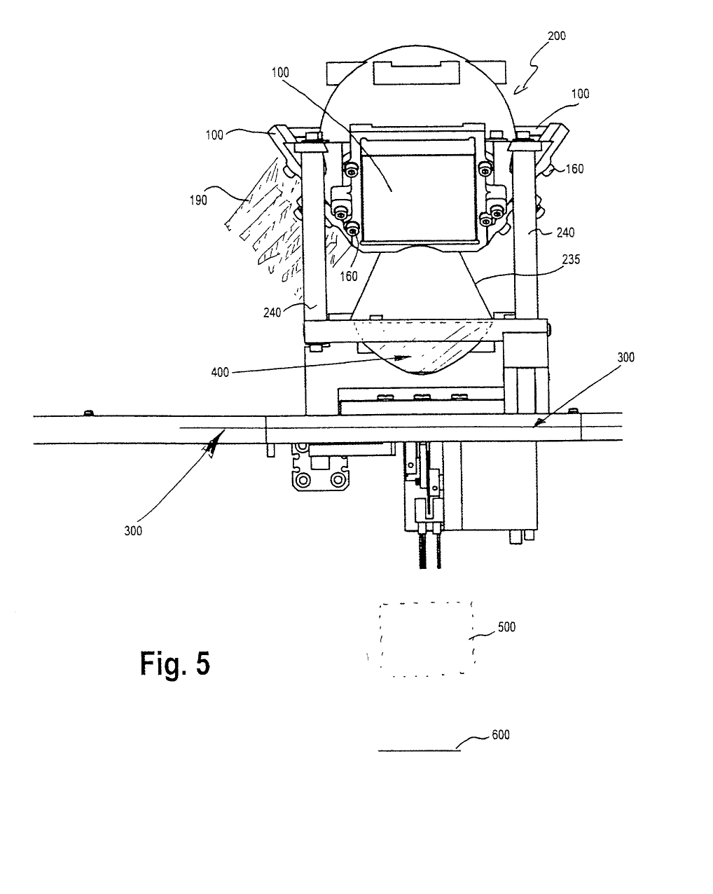

FIG. 5 shows an image capturing device in accordance with invention. The Ulbricht sphere 200 is provided with light emitting diode arrangements 100 in the region of the lower hemisphere. On the left side it is indicated that a cooling body 198 is connected with the light emitting diode arrangements 100, which functions as a heat sink. For example, LED chips of only a single color can be found on each of the light emitting diode arrangements 100, whereby the colors are different from light emitting diode arrangement to light emitting diode arrangements. This is especially advantageous when interference filters are positioned between the light emitting diode arrangements and the light integrator in order to filter the image light. The LED chips of different colors can be positioned on the same light emitting diode arrangement, especially LED chips of all colors used. A mechanical supporting arrangement 240 is provided for supporting the Ulbricht sphere. The light emitting diode arrangements 100 can be removably mounted to the input openings of the light integrator to allow the mounting, if desired, of different light emitting diode arrangements, for example, with LED chips of another emission color, to the light integrator. Mechanical fasting means, for example screws 160, are provided therefor.

A light cone 235 exits from the output opening of the Ulbricht sphere and impacts on the condenser lens 400. From there the light is guided onto an image positioned in the film plane 300. The light shines through this image and is captured by a lens system 500. The output opening of the light integrator is preferably projected by the condenser lens 400 onto the input opening of the lens system 500. The lens system 500 projects the film in the plane 300 onto a CCD. In a photo printer in accordance with invention, the same principle is used, but a photographic paper is used instead of a CCD.

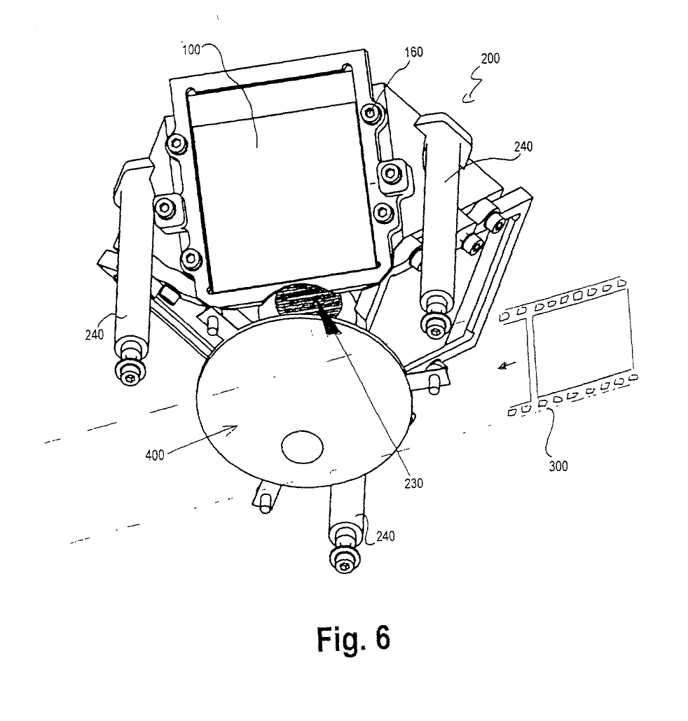

FIG. 6 shows a view from obliquely below of the Ulbricht sphere 200 shown in FIG. 5, whereby the same reference numerals refer to the same parts. The film 300 is guided through below the condenser lens 400. The output opening 230 of the Ulbricht sphere is clearly visible.

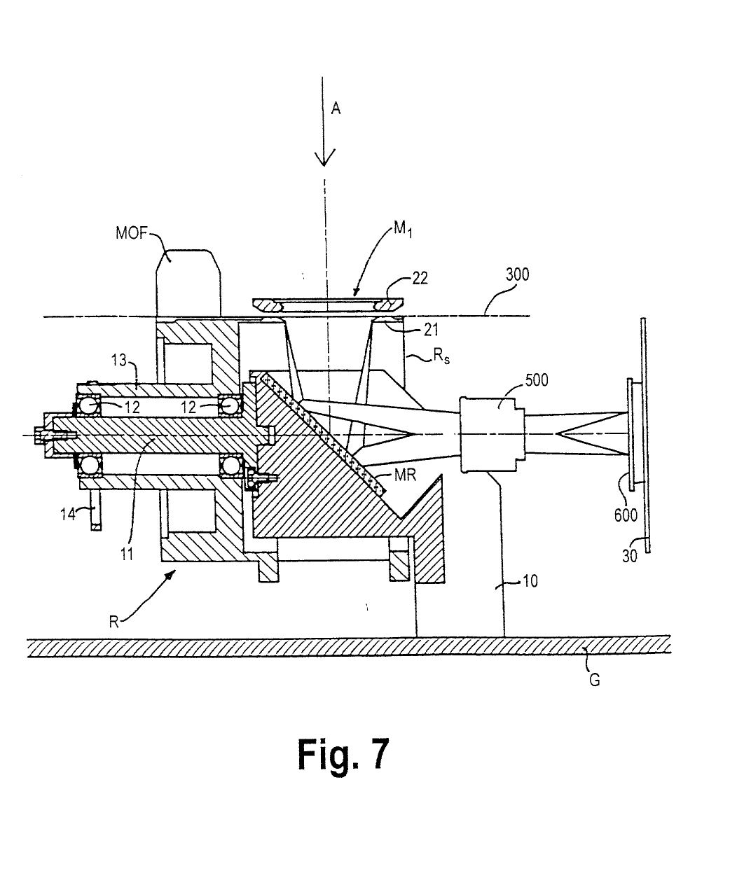

FIG. 7 shows an exemplary construction for the image capturing device starting with the film plane 300 and up to the detector 600. The angle of incidence of the light is designated by the arrow A. The film 300 is held by a mask M1 which includes a supporting mask 21 and a pressure mask 22 which is positioned at a small distance above the supporting mask and held by spring force so that a small gap remains between the supporting mask and the pressure mask through which the film 300 to be scanned is guided. A rotor R is provided on which several masks are mounted. A carrier 10 is fastened to a baseplate G, which carrier consists essentially of not further described beams respectively extending perpendicular and parallel to the baseplate. The parallel beams extend through the open front face Rs of the rotor and into the latter. A redirecting mirror which reflects the light entering in direction of the arrow A is mounted between the parallel beams in such a way that it is inclined at an angle of 45 degrees to the baseplate G. A supporting shaft 11 which extends parallel to the baseplate G is mounted at the free end of the parallel beams. The rotor R is rotatably mounted thereon by way of two ball bearings 12 and a bearing bushing 13 formed on the rotor R. The bearing bushing 13 and, thereby the rotor R, is driven by a motor 15 by way of a drive belt 14. The CCD 600 is held by a plate 30.

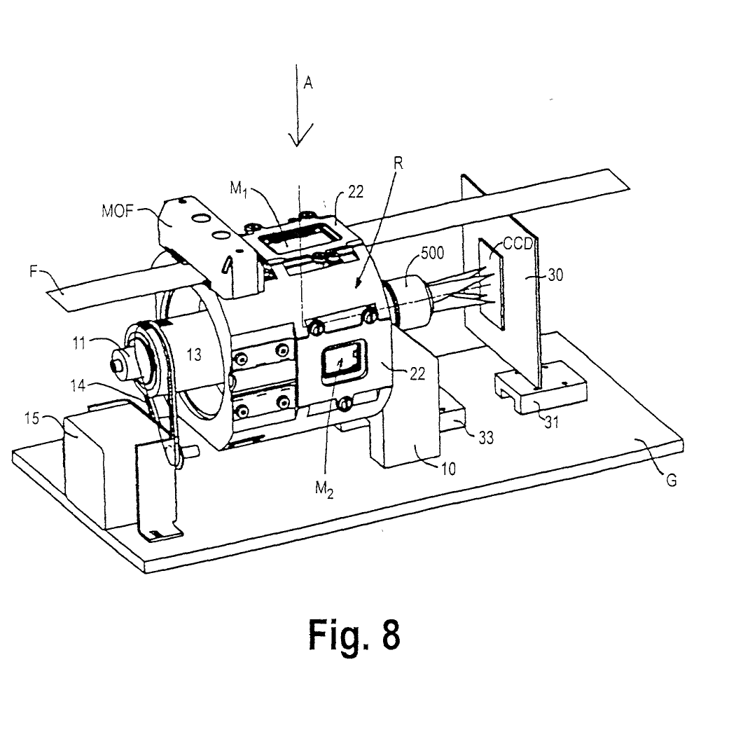

FIG. 8 shows a perspective view corresponding to the one of FIG. 7 in which a further mask M2 for another, namely smaller film format is apparent. Furthermore, a magnetic reader head MOF for the reading of the magnetic information on APS-films is provided.

The rotor together with the film masks forms the exchange mechanism for the positioning of different film masks as required into the preselected position for light transmission. A lens exchange mechanism can be mechanically or electrically (for example by way of a control) connected with the exchange mechanism, which lens exchange mechanism changes the position of the condenser lens according to the film format and the mask associated therewith, or changes the condenser lens by way of a carousel or revolver, in order to thereby adapt the size of the light cone exiting the output opening 230 to the mask size.

The rotor R is thereby rotatably supported on an axis which is essentially parallel to the longitudinal direction of the film transport path. The rotor R has at its circumference at least two film masks M1, M2 for different film formats. The film masks can be selected the inserted into the film transport path by rotation of the rotor R.

The use of the disclosed LED chip arrangement on each conducting substrates (light emitting diode arrangements) is not limited″ is with invention to photographic image capturing arrangements, but can generally be used as high intensity and quickly switching light source.

We claim:

1. Photographic capturing device for the capturing of photographic image information from photographic media, comprising a light integrator for receiving and homogenizing light emitted from LED chips in a color specific for the respective LED chip and for emitting the light from an output opening in order to illuminate a photographic medium carrying photographic image information, a detection means for detecting the light modulated by the photographic medium according to the image information, a number of LED chips each having a specific light emission color, the number of LED chips including LED chips of at least three different colors, the LED chips being mounted on at least one heat conducting substrate with the LED chips being in heat conducting contact with the substrate.

2. Photographic capturing device according to claim 1, wherein the at least one substrate is connected for heat conduction with a heat sink and conducts the heat taken up from LED chips to the heat sink.

3. Photographic capturing device according to claim 1, wherein the LED chips are so densely packed for the achievement of a high light density that they cover more than 10% of the surface over which they are distributed.

4. Photographic capturing device according to claim 1, wherein a microlens arrangement which includes a multitude of microlenses, is positioned on a light integrator side of the LED chips in such a way that each microlens is associated with one LED chip for the bundling of the light emitted therefrom.

5. The photographic capturing device according to claim 1, wherein the light integrator is formed as a cavity in which light is reflected and from which light is emitted through an output opening, whereby the LED chips are positioned at or in the input openings of the cavity in such a way that the chips directly illuminate a majority of the cavity without reflection and without directly illuminating the output opening.

6. Photographic capturing device according to claim 1, wherein respectively at least one group of blue, green and red emitting LED chips is provided, whereby more blue and green LED chips are provided than red LED chips.

7. Photographic capturing device according to claim 1, further comprising a control arrangement for the groupwise control of the LED chips, whereby each group includes LED chips of an emission color equal within the group but different from group to group, the control arrangement activating the light emission of the groups individually and sequentially respectively for a preselected time, whereby a photoelectric converter is provided as detection means for producing signals the reading of which is synchronized with the light emission of the groups for distinguishing the received emission color, so that the output signals can respectively be associated with the emission of a specific group.

8. Photographic capturing device according to claim 1, further comprising a first optical arrangement for exposing the photographic medium positioned at a preselected position onto the detection means, and a second optical arrangement for projecting the output opening enlarged onto the first optical arrangement.

9. Photographic capturing device according to claim 1, further comprising a holding arrangement for holding the photographic medium at a position preselected for the illumination, the holding arrangement including at least two masks, whereby each mask is provided for a photographic medium with different format, for selectively holding the photographic medium with a suitable mask at the preselected position, whereby respectively one of the masks is selectively positioned by way of an exchange mechanism at the preselected position.

10. The photographic capturing device according to one of claims 1 to 9, constructed as a scanner or printer.
